(19) United States
(12) Patent Application Publication
(10) Pub. No.: US 2007/0177158 A1
(43) Pub. Date: Aug. 2, 2007

(54) Method and apparatus for the two-dimensional mapping of the electro-optical coefficient

(76) Inventors: Marella De Angelis, Rome (IT); Pietro Ferraro, Rome (IT); Andrea Finizio, Rome (IT); Simonetta Grilli, Rome (IT); Paolo De Natale, Rome (IT); Sergio De Nicola, Rome (IT); Giovanni Pierattini, Rome (IT)

Correspondence Address: YOUNG & THOMPSON, 745 SOUTH 23RD STREET, 2ND FLOOR, ARLINGTON, VA, 22202, US

(21) Appl. No.: 10/592,682

(22) PCT Filed: Mar. 11, 2005
(86) PCT No.: PCT/IT05/00135

§ 371 Date: Nov. 14, 2006

(30) Foreign Application Priority Data
Mar. 17, 2004 (IT) RM2004A000133

(51) Int. Cl. G01B 9/02

(52) U.S. Cl. 356/521

(57) ABSTRACT

A method for measuring and two-dimensional mapping of electro-optical properties of materials using a Reflective Grating Interferometer (RGI) includes projecting a substantially coherent and monochromatic electromagnetic beam subjected to a homogeneous electrical field so the beam is enlarged to have a two-dimensional cross section comparable with dimensions of the material, dividing the electromagnetic beam into one part that crosses the material and another part that travels undisturbed, recomposing the two beams on a recombination element of the RGI, detecting the recombined beam by a device suited to two-dimensional detection of such beam. The method also includes: E. obtaining phase variation Δø(x,y) between the divided beams; F. varying the applied electrical field value and repeating the detection steps; G. calculating properties using:

$$Δ Φ ( x , y ) = ( \frac{π}{λ} ) \cdot [ - {n}_{0}^{3} ( x , y ) \cdot {r}_{13}^{′} ( x , y ) \cdot V ]$$

where ΔΦ=phase difference, V=value of the voltage difference, r′₁₃=electro-optical parameter, and n₀=ordinary refraction index. A corresponding apparatus is also described.

The present invention concerns a method for the two-dimensional mapping of the electro-optical properties of transparent objects, a cell to be used in such a method for the application of an electrical field to objects, and relevant apparatus.

More particularly, the present invention is concerned with a method for determining the electro-optical properties of transparent objects and for the two-dimensional mapping thereof. The method applies in particular to those objects and devices, for which one desires to know the uniformity of their response to an electrical field, and to those objects which present structures with different electro-optical structures and of which one desires to know the two-dimensional mapping. The invention concerns further a cell into which can be placed such transparent materials and is suited to create in them an electrical field according to the needs of the method of the invention. Last but not least, the invention concerns an apparatus which realises the method according to the invention, notably using the cell according to the invention.

There are materials, as for example crystals without centre of symmetry, in which it is present a birefringence induced by the linear electrical field, which is called linear electro-optic effect or Pockels effect; it is proportional to the electrical field and therefore to the applied voltage.

The delay of a light beam crossing such crystals can be changed at will by means of an applied electrical field and this is the reason why such crystals are often used as phase modulators, polarisation modulators, in amplitude modulators, as optical switches and in general as optical and photonic devices (see A. Yariv “Quantum Electronics” Wiley Ed., New York 1988).

During last years, a great effort has been done in the research in order to produce new crystals suitable to show a good electro-optical effect, and the development of such materials adds continuously new crystals to the list of those already existing; it is therefore extremely interesting to have at disposal high-resolution techniques, which are reliable and easy-to-use for studying of electro-optical properties of crystals.

In a large number of applications, both in scientific and industrial field, a need exist to measure with enough accuracy electro-optical properties, notably the so-called electro-optical coefficient, of non-uniform structures, and therefore to have a multi-dimensional map of the structure under examination.

For example, in crystals of photonic interest, the ferroelectric polarisation of the crystal is inverted by means of a process called of alignment of the ferroelectric domains or “poling”, induced by an external electrical field. Such a process generates inside the crystal micrometric or submicrometric structures distributed according to 1, 2 or 3 dimensions, which interact differently with the light radiation. In this type of structure, it is crucial the knowledge of phase variation induced by the crystal on the incident light, both in rest conditions and under conditions of externally induced stresses, as for example an electrical field. Since the structure can be either one-dimensional or bi- or three-dimensional, the need of having at disposal measurement techniques for two- or multi-dimensional mapping of the phase response of the crystals, which have undergone engineering processes of ferromagnetic domains, is nowadays more and more felt. For the same reason, is today necessary a technique which allows the on-site monitoring of the formation of the ferroelectric structures.

From now on, we will focalise on the linear electro-optical or Pockels effect, it should be however clear that what we will state will be also valid for the other electro-optical properties (for example, the Kerr or quadratic electro-optical effect, the piezoelectric effect or, better, the inverted piezoelectric effect: it deals with a variation in the shape and/or dimensions of the sample when is placed in an electrical field).

The methods used at present for measuring the electro-optical properties are of local type, concerning only a small area of the sample, and provide an average information in the analysed area.

Up to now, several techniques have been proposed for measuring the electro-optical coefficients in birefringence crystals. Some are polarimetric, as the Senarmont type (see in this concern P. C. Lemaire, and M. P. Georges, Optical Material 4, (1995) 182-187; K. Chah, M. Aillerie, M. D. Fontana, and G. Malovichko, Optics Communication 176, (2000) 261-265), some others are interferometric, since they use interferometers of Michelson or Mach-Zehnder type. The former are simple experimental apparatuses, the latter requires the use of more complex apparatuses and are very sensitive to vibrations.

During last years, many improvements have been done in the interferometric-type techniques, enabling the reach of high sensibilities in the measurements. It has been used for example a Michelson interferometer (P. Ney, A. Maillard, M. D. Fontana, and K. Polgàr, J. Opt. Soc. Am. B 17, (2000) 1158-1165), which includes an electro-optical modulator in one of the branches of the interferometer. With this apparatus, one is able to determine very small differences of optical path, by measuring the phase shift of the reference modulator which is needed to compensate for the phase shift caused by the application of the static electrical field of the crystal.

It has been proposed recently (P. Delaye, and G. Roosen, Optics Communication 214, (2002) 199-206) a technique based on a Mach-Zehnder interferometer, which enables measurements having a good sensibility without any stabilisation of the apparatus, thanks to an innovative data processing system.

Another interferometric method with signal modulation exists for precise measurements of electro-optical coefficients (J. A. de Toro, M. D. Serrano, A. Garcia Cabañes, and J. M. Cabrera, Optics Communication 154 (1998) 23-27); a good accuracy is reached by obtaining the signal of first and second harmonic of the frequency modulation, while the phase is electronically varied along the two interference orders.

Further, it has been developed a method (X. Yin, Q. Pan, W. Shi, and C. Fang, Applied Optics 41 (2002) 5929-5932) which is based on a Twyman-Green interferometer which uses the piezo-electric effect of a quartz crystal in order to compensate for the optical path changements caused by the electro-optical effect of the sample.

According to another approach (J. Koo, C. Lee, J. H. Jang, K. No, and B. Bae, Applied Physics Letters 76 (2000) 2671-2673), the electro-optical coefficient is measured by using an interferometer with two beams provided with perpendicular, linear polarisations: an electrical field applied to the sample to be analysed induces different phase shifts between the interfering beams.

The above-mentioned measurements are point measurements and are integrated on the sample thickness. As a consequence, an extension of such techniques to a two-dimensional mapping requires long measurement periods to disadvantage of the correlation between measures carried out at different times. These aspects make the carried out measurements operations slow, expensive and not much reliable.

Moreover, for the application of the electrical field to the sample to be analysed, it is customary to deposit transparent solid electrodes which prove to be invasive and not easy to be realised unless one has specific and expensive equipments.

In the article of Storrow G. M. et al. “An analysis of the optical properties of a single-element liquid crystal device”, Pure and Applied Optics IOP Publishing UK, vol. 7, no. 6, November 1998(1998-11), pages 1411-1423, it is disclosed a method for phase imaging for measuring optical properties of an electrically controlled birefrangent liquid crystal at electrode edges, i.e. in the part of the material subjected to fringing fields. Such a method uses a Michelson interferometer and let the beam pass through the sample twice. It uses the phase-stepping interferometry technique, where three images have to be detected in order to retrieve the phase difference between the beam transmitted by the sample and the reference beam, each time for a specified value of the external voltage.

In the article of De Angelis et al. “Interferometric analysis of a lithium niobate with engineering reversed domains”, Proceedings of the SPIE SPIE-Int. Soc. Opt. Eng. USA, vol. 5144, 2003, pages 745-752, it is disclosed a method for measuring discontinuities of electro-optical properties in materials transparent to the electromagnetic radiation, using a reflective grating interferometer. The method comprises the acquisition of two images of a sample not subjected to any electrical field, one with the sample and one without the sample in the experimental set-up.”

It is an object of the present invention to provide a method for measuring the electro-optical coefficient of transparent materials, solving the above-mentioned drawbacks.

It is also an object of the present invention to provide a cell for the application of the electrical field to a material, the cell being suitable to be used in the method which is object of the invention.

It is further specific object of the present invention an apparatus for measuring the electro-optical properties of transparent materials solving the above-mentioned drawbacks.

It is specific subject matter of this invention a method for measuring and two-dimensional mapping of the electro-optical properties of materials transparent to the electromagnetic radiation, comprising a first step A of reproducing of a substantially coherent and monochromatic electromagnetic beam, a subsequent step B of projection of the beam onto the transparent material to be analysed which is subjected to an electrical field, a subsequent step C of processing of said beam by means of an interferometric system and a subsequent step D of detection of the beam exiting from said interferometric system, characterised in that the projection of step B is realised in such a way that the beam is enlarged as far as to have a two-dimensional cross section comparable with the dimensions of the material to be analysed, the detection step being realised by means of device suited to two-dimensionally detect the beam exiting from the interferometric system.

Preferably according to the invention, the method further comprises the steps:

B.1 during step B, dividing said electromagnetic beam in two parts, in such a way that one part crosses the material, the other part travels undisturbed;

C.1 during step C, recomposing the two beams on a recombination element of the interferometric system;

E. subsequently to step D, obtaining from the detected electromagnetic beam, which is representative of a two-dimensional image, the phase variation of the electromagnetic beam which has crossed the material with respect to that of the undisturbed electromagnetic beam;

F. subsequently to phase D, for a number of P times, varying the applied electrical field value and repeating the preceding steps;

G. calculating the two-dimensional electro-optical properties of the material under examination, starting from the phase delay for each point of the two-dimensional image of the detected electromagnetic beam with respect to the reference beam, from the value of the applied voltage difference, from the value of the refraction index of the material to be analysed at the wavelength of the electromagnetic beam of step A.

Preferably according to the invention, said transparent material to be analysed is a non-centre-symmetrical crystal.

Preferably according to the invention, the dimension perpendicular to the surface of the material, of which one detects the two-dimensional electro-optical properties, have thickness of less than 5 mm.

Preferably according to the invention, the dimension perpendicular to the surface of the material, of which one detects the two-dimensional electro-optical properties, have thickness of less than 0.5 mm.

Advantageously according to the invention, said detected beam is analysed in step E by means of an algorithm of digital holography which enables to reconstruct the phase profile of the object beam on the plane of the material under examination.

Preferably according to the invention, the algorithm of digital holography utilises the numerical calculation of the diffraction integral in the Fresnel approximation, according to the following steps:

transforming the detected interferometric image into a digitised interferogram, composed by a number of Vᵣ values of signal intensity, described by an array H(n·Δx,m·Δy) of N·M values, where n and m are integers, Δx and Δy are the sampling intervals along the x and y axis respectively and (N·Δx)(M·Δy) is the area of the acquired hologram;

multiplying the digitised hologram H(n·Δx,m·Δy) by a digitised replica of the reference beam R(n·Δx,m·Δy), whereby obtaining the relation:
H(nΔx,mΔy)·R(nΔx,mΔy)=R|R|²+R|O|²+RR*O+RRO*

reconstructing the image from the plane in which it has been detected to the plane in which the material to be analysed is put, by means of numerical calculation of the diffraction integral in the Fresnel approximation with the discrete formulation of the Fresnel integral expressed in terms of the Fourier transform, that is:

$$\begin{matrix}Ψ ( l Δ x , k Δ y ) = A {ⅇ}^{\frac{ⅈ π}{λ d} ( {l}^{2} Δ {ξ}^{2} + {k}^{2} Δ {n}^{2} )} DFT \\ {[ R ( n Δ , m Δ y ) H ( n Δ , m Δy ) {ⅇ}^{\frac{ⅈ π}{λ d} ( {n}^{2} Δ {x}^{2} + {m}^{2} Δ {y}^{2} )} ]}_{l , k}\end{matrix}$$

where λ is the wavelength of the source, A is a complex constant, n, m, l, k are integers (−N/2+1<n,l<N/2 e−M/2+1<m,k<M/2), DFT is the discrete Fourier transform, Δx and Δy are the sampling intervals of the interferogram, d is the distance between the plane of the detection device and the observation plane, and, finally, Δξ and Δη represent the spatial sampling intervals in the observation plane and are defined by Δξ=λd/NΔx and Δη=λd/MΔy;

calculating the phase difference according to the formula:

$$Δ ϕ ( l Δ x , k Δ y ) = arctan \frac{Im Ψ ( l Δ x , k Δ y )}{Re Ψ ( l Δ x , k Δ y )}$$

Preferably according to the invention, the electro-optical parameter r′₁₃ is calculated for each pixel, by the formula:

$$Δ Φ ( x , y ) = ( \frac{π}{λ} ) \cdot [ - {n}_{0}^{3} ( x , y ) \cdot {r}_{13}^{′} ( x , y ) \cdot V ]$$

Advantageously according to the invention, the method comprises a processing step of the digitised hologram array, and a step of reconstruction in the complex plane starting from the digitised hologram processed in the first step, in the reconstruction step being effectuated a discrete Fresnel transformation starting from an array of Vₑ values, comprising said Vᵣ values of signal intensity values corresponding to as many elementary pixels of the holographic image, the pixel sizes being equal to the holographic image sampling intervals, as well as an integer number p=Vₑ−Vᵣ>0 of constant values equal to OS, corresponding to as many pixels of sizes equal to the ones of the others.

Preferably according to the invention, said p constant values are null values (OS=0).

Preferably according to the invention, said p values are arranged externally to said array of Vᵣ values.

According to the invention, said p values can be arranged in a symmetrical way.

According to the invention, said p values can be arranged in a non-symmetrical way.

Preferably according to the invention, said number Vₑ of values is inversely proportional to the desired pixel size to be obtained for the reconstructed image.

Preferably according to the invention, the digitised hologram is a square array of Vᵣ=Nᵣ·Mᵣ values, each value corresponding to a square pixel of sizes Δx, Δy.

Preferably according to the invention, the hologram reconstructed in the second step is represented by a square array of Vₑ=Nₑ·Mₑ values, each value corresponding to a square pixel of sizes Δξ=(λd/NₑΔx) and Δη=(λd/MₑΔy), λ being the wavelength of the wave beam striking the object of which the hologram is recorded, and d the distance between the detection device and the object of which the hologram is detected, Δξ and Δη being the reconstructed holographic image sampling intervals.

Preferably according to the invention, Nₑ=(λd/Δx²), Mₑ=(λd/Δy²), Δξ=Δx, Δη=Δy.

Advantageously according to the invention, after the second step, if each holographic image sampling interval is not equal or less than a certain threshold, the number of values p added to the digitised hologram array is increased and the second step is carried out again.

Advantageously according to the invention, said threshold is a function of the signal-to-noise ratio of the holographic image.

It is further specific subject matter of this invention a cell for applying an electrical field to a material, the cell being to be used in the method according to the invention, the cell comprising two liquid electrodes connectable to supply means, characterised in that it comprises a chamber suited to receive liquid electrodes from at least two separate accesses, a system for fixing the material, the chamber and the system for fixing the material being such that, by fixing the material, a first and a second separated electrode chambers are created, each one provided with at least one of said at least two accesses for liquid electrodes, the liquid electrodes in the first and in the second electrode chamber contacting the material on the surfaces of the two sides delimiting respectively the first and second electrode chamber.

Preferably according to the invention, the system for fixing the material is electrically neutral.

According to the invention, the fixing system can comprise seal means in isolating material, preferably in rubber.

Advantageously according to the invention, said fixing system delimits a part of the first and a part of the second electrode chamber.

Preferably according to the invention, the cell comprises at least two accesses for electromagnetic radiation to the material, such that at least a part of the electromagnetic radiation can cross the cell and the material in its passage.

Preferably according to the invention, said electromagnetic radiation is in the optical region.

Preferably according to the invention, said accesses for electromagnetic radiation are made of quartz.

Preferably according to the invention, the liquid electrodes comprise a solution of water and ions.

Advantageously according to the invention, said supply means comprise a high-tension supplier.

It is further specific subject matter of this invention an apparatus for measuring and two-dimensional mapping of the electro-optical properties of transparent materials, comprising a source of coherent and single-mode electromagnetic beam, a system of transmission, and projection of said beam, an interferometric system of treatment of the projected electromagnetic beam, a device for detecting of the electromagnetic beam exiting from the interferometric system and a processing unit for processing the information relevant to the detected electromagnetic beam, characterised in that it further comprises a cell wherein the material to be analysed has to be placed, the cell and said material being crossable by at least a part of the projected electromagnetic beam, the cell being suited to crate an electrical field in the material.

Preferably according to the invention, the apparatus implements steps A to G in the method according to the invention.

Preferably according to the invention, said electrical field is uniform.

Preferably according to the invention, the cell is the cell according to the invention.

Preferably according to the invention, the electromagnetic beam is let from the source in a single-mode, polarisation-maintaining fibre through the fibre coupling system.

Preferably according to the invention, the electromagnetic beam is directed towards the interferometric system in such a way that at least a part of it crosses the cell.

Preferably according to the invention, the electromagnetic beam is emitted from an end of the single-mode, polarisation-maintaining fibre towards a parabolic mirror, which directs said electromagnetic beam towards the interferometric system, in such a way that a part of the beam crosses the material in the cell and another part arrives undisturbed at the interferometric system.

Preferably according to the invention, the parabolic mirror is placed at a distance from the end of the single-mode, polarisation-maintaining fibre such that the electromagnetic beam is collimated and expanded to dimensions which are comparable to those of the material.

Preferably according to the invention, the interferometric system comprises a wave front division interferometer.

Preferably according to the invention, the interferometric system comprises a diffraction grating on which impacts the part of the electromagnetic beam which has crossed the material.

Preferably according to the invention, the interferometric system comprises a flat mirror mounted on adjustable supports on which impacts the part of the electromagnetic beam which has not crossed the material.

Preferably according to the invention, the mirror is controlled so that the electromagnetic beam is redirected towards the diffraction grating.

Advantageously according to the invention, the processing electronic unit generates a signal suited to control said adjustable supports.

Advantageously according to the invention, the processing electronic unit generates signals suited to control the emission of the coherent light by said source and/or the electrical field applied to the material.

Preferably according to the invention, the detection device of the electromagnetic beam is a two-dimensional array of detectors of electromagnetic radiation, more preferably a CCD camera.

Advantageously according to the invention, the processing unit processes the data according to step E and/or G of the method according to the invention.

The invention will be now described, by way of illustration and not by way of limitation, by particularly referring to the drawings of the enclosed Figures, in which:

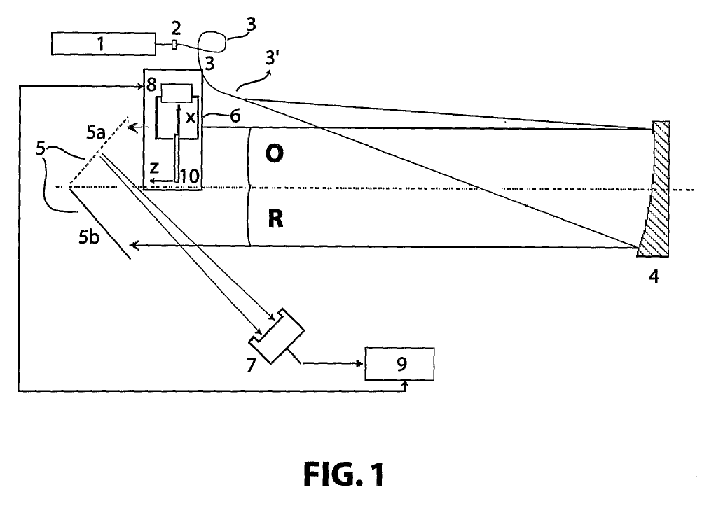

FIG. 1 shows a schematic representation of the apparatus according to the invention for the two-dimensional mapping of the electro-optical properties of samples of transparent materials;

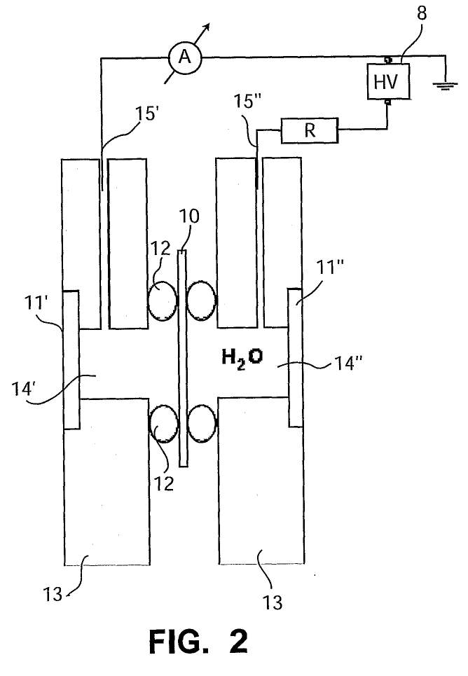

FIG. 2 shows a schematic representation of the cell according to the invention;

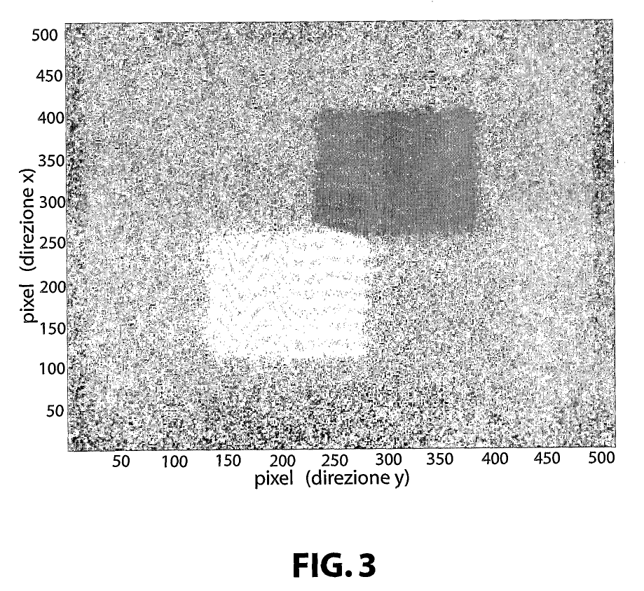

FIG. 3 shows a diagram in which it is reproduced the phase map deformed by the electro-optical effect of a sample of transparent material, obtained by elaborating the interferometric signal;

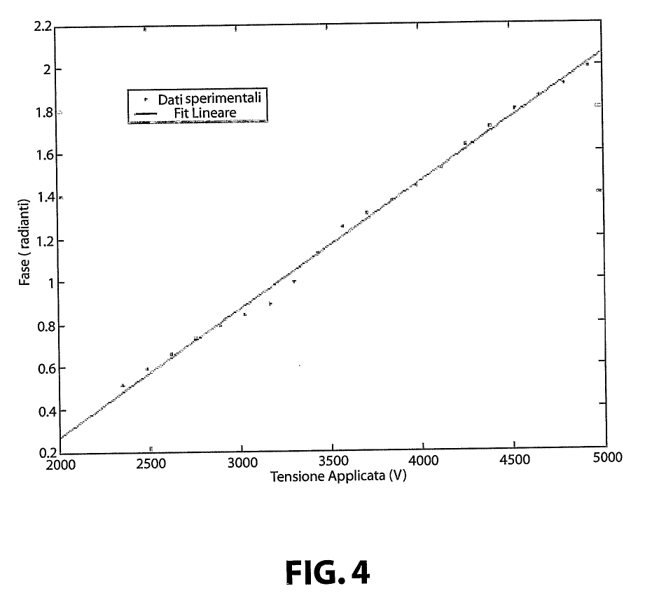

FIG. 4 shows a diagram wherein it is reproduced the phase linear variation induced on the light radiation crossing the sample, in the event that the sample is nominally uniform in the electro-optical behaviour in the XY plane, as a function of the voltage applied to the sample;

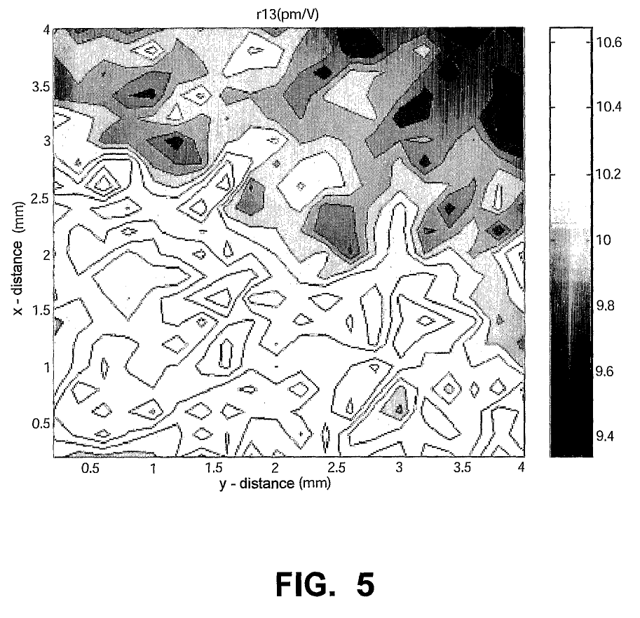

FIG. 5 shows a diagram in which it is reproduced a two-dimensional mapping of the electro-optical properties of the sample relevant to FIG. 4;

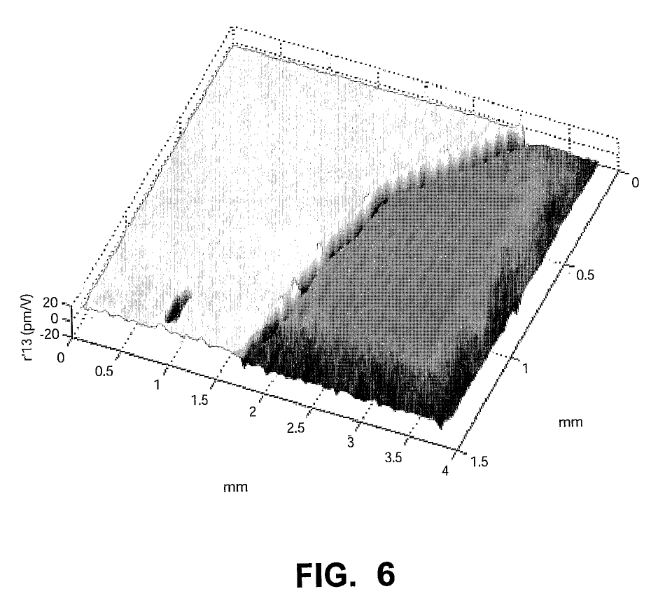

FIG. 6 shows a three-dimensional graph wherein it is plotted the two-dimensional mapping of the electro-optical properties of the sample relevant to FIGS. 4 and 5, treated beforehand.

According to a preferred embodiment, the method in accordance with the invention briefly comprises the following phases:

a monochromatic, coherent light beam is produced, which is divided into two parts, a part crosses the sample whose electro-optical coefficient is to be measured (object beam O) and its phase is altered as a function of the electro-optical coefficient of the sample, the other part travels undisturbed (reference beam R) and provide the reference phase of the light radiation;

the two beams are recomposed on a diffraction grating which represents the recombination element of the utilised interferometric system;

by observing the interference signal, one deduces the phase variation, and therefore the wave front variation, of the radiation beam which has crossed the sample with respect to that of the undisturbed radiation; such a signal is recorded by an integrated, two-dimensional array of radiation detectors;

such a phase variation is deduced for different values of the electrical field applied to the sample, afterwards one executes as many measurements as electrical field values are applied to the sample;

knowing the applied voltage difference and the refraction index of the sample at the wavelength of the incident light, one deduces the contribution of the electro-optical effects of the material under examination by means of a two-dimensional mapping.

For expository clarity, before going deeply into the matter of the analysis that leads to the calculation of the two-dimensional, electro-optical properties, it is illustrated an embodiment realising the apparatus which implements the method according to the invention.

With reference to FIG. 1, all the parts which compose the apparatus according to a preferred embodiment are listed in the following:

1 laser source,

2 system of fibre coupling,

3 single-mode, polarisation-maintaining fibre,

4 parabolic mirror,

5a diffraction grating,

5b flat mirror on stable and adjustable supports (tiltmeters),

6 cell for the sample to be analysed,

7 CCD camera for acquiring images,

8 signal generator and high-voltage amplifier,

9 electronic processing unit.

A coherent laser source 1 generates a laser beam, which is launched by means of the coupling means 2 in an optical single-mode fibre 3 which is suitable to maintain the polarisation.

The beam exits from the optical fibre 3 with a highly diverging spherical wave front and is collimated by means of a parabolic mirror 4 (for example of the diameter of around 15 cm).

One part of the beam crosses the sample, the other travels undisturbed. The cell 6 containing the sample is suitable to provide a high-quality optical access thanks to two quartz optical windows. Further, thanks to two seal chambers, it allows to inject a liquid electrode which therefore is in contact with both sides of the sample and assures a uniform electrical field on the sample.

The liquid electrode is in general constituted by any conductive solution, for example by water with an ion concentration ranging from the average aqueduct concentration (about 180 mg/l) to that of a lithium-clorure-water solution (about 21200 mg/l).

When an electrical field is applied to the sample, the object beam O undergoes a phase variation.

The electrical field applied to the sample corresponds to a high-voltage signal produced by the amplifier 8 which is powered by a function generator.

The system comprising generator and amplifier is controlled by an electronic processing unit 9, so as to predefine the type of field that one wishes to use for characterising the sample (constant, or linear-“ramp” signal or other type of signal), and in this way to adjust the emission of the source 1.

The part O of the light beam crossing the sample arrives directly on the diffraction grating 5a and is diffracted towards the CCD camera 7, the part R of the light beam travelling undisturbed is first reflected on a flat mirror 5b and subsequently diffracted by the grating 5a on the CCD camera, which is in general constituted by a two-dimensional integrated array of radiation detectors.

With a suitable choice of angles of incidence, both beams superimpose on grating 5a in order to generate an interference image which carries the information of deformation of the phase variation undergone by the wave front of the light beam O crossing the sample 10 with respect to the wave front of the undisturbed beam R.

As it can be seen, the analysis of the wave front is made utilising a division-of-wave-front interferometer 5 wherein the recombination element 5a is a diffraction grating (see also, for example, Patent Request No RM96A000178 filed on 19th March 1996 and the article of M. de Angelis et al., in Pure and Applied Optics, vol. 24 (1995) 761-765).

The digitised image detected by the device 7 is then stored in the processing electronic unit 9.

The recorded interferometric image is analysed by means of an algorithm of digital holography, that is described in the following. This algorithm enables the two-dimensional reconstruction of the phase profile of the object beam which has undergone the variation (see also, for example, the article of S. De Nicola et al., Optics Letters, 26(13) 2001,974-876 and the Patent request No RM2003A000398 deposed the 13th August 2003).

In FIG. 2 is reproduced a schematic representation of the cell that enables to apply an uniform electrical field and to assure the optical access to the material sample to be analysed.

The configuration of the cell 6 is of “longitudinal” type, i.e. the electrical field is directed in the same propagation direction of the light needed to measure the phase variation induced in the crystal 10 under the effect of the electrical field.

One of the sample utilised for verifying the working of the apparatus according to the invention is composed by a crystal of lithium niobate of the thickness of about 0.5 mm in which are present two bordering regions characterised by different electro-optical behaviours.

In the case of this sample, on which the electrical field is applied, the phase variation is mainly determined by the linear electro-optical and the piezoelectric effects.

The sample could be thinner than the utilised one, since the apparatus according to the invention can appreciate phase variation, over optical paths, smaller than a micron.

The sample is fixed by two rings 12 which are made of rubber or every other type of material that assures the seal. The rubber rings 12 allows to form two water seal chamber 14′,14″ wherein can be introduced a liquid electrode (generally a ion-rich water solution). In this manner, it is possible to apply to the sample an homogeneous electrical field.

Two quartz windows 11′,11″ enable a high-quality optical access, in the sense that they introduce deformations of negligible magnitude in the wave front of the radiation crossing the sample 10.

The output cable of a high-voltage amplifier 8 is connected directly to the liquid contained in the seal chambers in order to provide the sample with the necessary voltage.

The cell according to the invention is therefore conceived so as to assure a high-quality optical access and at the same time to apply the necessary electrical field by means of liquid electrodes 15′,15″: this expedience allows to avoid the deposition of transparent, solid electrodes which are expensive and further are invasive since their removal is possible only by means of chemical processes based on acids.

Coming now to the method of calculation of the electro-optical properties according to the invention, the effects of an electrical field on the propagation are properly expressed by the variations of the refraction indexes 1/nᵢ², with i=1, . . . ,6 and corresponding to the components x, y, z, xy, xz, yz, caused by the arbitrary electrical field E and defined by the following equation (1):

$$Δ ( \frac{1}{{n}^{2}} ) = {\sum }_{j = 1}^{3} {r}_{i j} {E}_{j}$$

where the sum is made on the three components of the electrical field Eⱼ and rᵢⱼ is the electro-optical tensor which has 18 independent elements and can be written as a 6×3 array.

The tensor is not null only for crystals which are not centre-symmetric.

The form of the tensor rᵢⱼ can be deduced from the crystal's symmetry, that imposes which of the elements of the tensor are null and which relations exist between the remaining elements. In the case of the lithium niobate, for instance, the tensor is of the type given by the following expression (2):

$${r}_{i j} = \vert \begin{matrix}0 & - {r}_{22} & {r}_{13} \\ 0 & {r}_{22} & {r}_{13} \\ 0 & 0 & {r}_{33} \\ 0 & {r}_{42} & 0 \\ {r}_{42} & 0 & 0 \\ - {r}_{22} & 0 & 0\end{matrix} \vert$$

Where one sees that only 4 independent elements are necessary to describe the effect of electrical field.

For example, to measure the term r₁₃ one uses a “longitudinal” configuration: the uniaxial crystal, in the absence of applied electrical field, is placed in such a way that the optical axis is along the direction of light propagation and thus the applied electrical field as well. For such a type of alignment, the application of the electrical field does not change the polarisation state of the light, rather it varies the phase of the light radiation crossing the sample.

Besides the variation of the refraction index due to the linear, electro-optical effect, there is a variation of the crystal thickness caused by the piezoelectric effect which depends on the components of the so-called “piezoelectric strain” tensor d₃₃ in a way analogous to the dependence of the refraction index on the electro-optical tensor. In the end, the variation of the light radiation phase can be expressed by the following formula (3):

$$\begin{matrix}Δ Φ ( x , y ) = ( \frac{π}{λ} ) \cdot [ - {n}_{0}^{3} ( x , y ) \cdot {r}_{13} ( x , y ) + 2 {n}_{0} \cdot {d}_{33} ( x , y ) ] \cdot V \\ = ( \frac{π}{λ} ) \cdot [ - {n}_{0}^{3} ( x , y ) \cdot {r}_{13}^{′} ( x , y ) \cdot V ]\end{matrix}$$

where with r′₁₃ it is indicated the so-called electro-optical parameter corresponding to the overall contribution of the linear electro-optical effect and of the piezo-electric effect, r₁₃ is the electro-optical coefficient expressed in mN, n₀ is the ordinary refraction index, V is the voltage difference in Volt and λ is the wavelength in metres.

In order to measure the r₃₃ term, a so-called “transversal” configuration is used, in which the applied electrical field is perpendicular to the light propagation direction and the latter is perpendicular to the optical axis of the crystal. Other analogous configurations are possible in order to measure the remaining elements of the electro-optical tensor.

In order to extract the phase profile of the wave front deformed by the sample due to the electro-optical effect, the interferometric signal is analysed by means of an algorithm called of digital holography and hereafter described.

The interference image can be described in terms of two-dimensional distribution of intensity, according to the following formula (4):
H(x,y)=|R(x,y)|2+|O(x,y)|2+R*(x,y)O(x,y)+R(x,y)O*(x,y)

where R, O, R* and O* are respectively the reference beam, the object beam and their complex conjugates.

When detected by the image-detecting device (CCD camera), the interferometric image is transformed in a digitised interferogram, composed by a number Vᵣ of signal intensity values.

The image is acquired, digitised and stored on an electronic processing device. The digitised image is called “digital hologram” and is described by an array H(n·Δx,m·Δy) of N·M values, obtained by the two-dimensional spatial sampling of the interferogram H(x,y), where n and m are integers, Δx and Δy are the sampling intervals along x and y axis respectively, and (N·Δx)(M·Δy) is the area of the acquired hologram image.

The process of numerical reconstruction of the wave front of the object beam is based on two steps.

In the first step, the digitised hologram H(n,m) has to be multiplied by a digitised replica of the reference beam R(x,y), obtaining the following relation (5):
F(nΔx,mΔy)=H(nΔx,mΔy)·R(nΔx,mΔy)=R|R|²+R|O|²+RR*O+RRO*

where the first two terms correspond to the zero order of diffraction, from the third and/or fourth terms being possile to deduce the image of the observed object.

The second step of the propagation process consists in the reconstructing of the image from the plane in which the array of radiation detectors is placed to the plane in which the object is put. Such a reconstruction can be made through numerical calculation of the diffraction integral in the Fresnel approximation.

The advantages of such an approximation is based on the fact that its computation is simple and can be executed in a very rapid manner. In the case of the Fresnel approximation, the numerical reconstruction will be effectuated by means of a discrete formulation of the Fresnel integral expressed in terms of Fourier's transform, i.e. according to the following formula (6):

$$\begin{matrix}Ψ ( l Δ x , k Δ y ) = A {ⅇ}^{\frac{ⅈ π}{λ d} ( {l}^{2} Δ {ξ}^{2} + {k}^{2} Δ {η}^{2} )} DFT \\ {[ R ( n Δ , m Δ y ) H ( n Δ , m Δy ) {ⅇ}^{\frac{ⅈ π}{λ d} ( {n}^{2} Δ {x}^{2} + {m}^{2} Δ {y}^{2} )} ]}_{l , k}\end{matrix}$$

where λ is the wavelength of the source, A is a complex constant, n, m, l, k are integers (−N/2+1<n,l<N/2 and −M/2+1<m,k<M/2), DFT is the discrete Fourier transform, that can be calculated in a fast way making resort to the various algorithms of Fast Fourier Transform (FFT) reported in literature, Δx and Δy are the sampling intervals of the interferogram (therefore in the camera plane), d is the distance between the camera plane and the reconstruction plane, and finally Δξ and Δη represent the sampling spatial intervals in the reconstruction plane and are defined by: Δξ=λd/NΔx e Δη=λd/MΔy.

Once Ψ(lΔx,kΔy) has been calculated, it is possible to obtain both the intensity and the complex amplitude of the image. For our purposes, the phase is given by the following expression (7):

$$Δ ϕ ( Δ x , Δ y ) = arctan \frac{Im Ψ ( l Δ x , k Δ y )}{Re Ψ ( l Δ x , k Δ y )}$$

The phase profile obtained by means of the analysis process of digital holography, for the above-mentioned lithium-niobate sample, is shown in FIG. 3, wherein the two orders of diffraction of the Fresnel integral are recognisable.

The just described analysis process of the interferometric image enables the numerical reconstruction of the image on the crystal plane and the focusing of the object with a direct correspondence between phase map and sample's coordinates.

Other algorithms of analysis of interferometric images need the addition of lens in the experimental apparatus and relevant optical focusing, and do not assure the direct correspondence in dimensions of the sample and image.

In FIG. 4 the diagram of the phase variation induced on the light radiation crossing the lithium-niobate sample is reported, in the case in which the sample is nominally uniform, as a function of the voltage applied to the sample.

According to equation (3), the straight line best approximating experimental data has been plotted. Such a straight line has been deduced, in the specific example, using the least squares method that provides the best estimation of the straight line slope. From the latter and the knowledge of the ordinary refraction index under examination and of the light wavelength, one deduces the value of the electro-optical parameter r′₁₃.

The process just described that leads to the estimation of the electro-optical coefficient can be applied to any point individuated by the coordinates (x,y) or region of the phase map, shown in FIG. 4. In such a way, to each point in the plane xy of the sample under examination is associated an electro-optical coefficient's value. Such association is made contextually for all the points, thus by only one measure one obtains the electro-optical parameter of the sample.

Such result is shown in FIG. 5, wherein it is reported the two-dimensional mapping of the electro-optical parameter r′₁₃ of the sample nominally uniform on the plane XY, on which the measurement procedure highlights different values of the electro-optical parameter itself, expressed in pm/V (picometers/Volt).

The right-hand column of FIG. 5 shows the distribution of the values obtained for the given sample: the average value of the electro-optical parameter obtained for this sample is 10 pm/V.

The same procedure has been applied for an intentionally non-uniform sample, in which there is a structure with regions with different behaviour.

The results is recognisable in FIG. 6, where it is reported the two-dimensional mapping of the electro-optical parameter of a lithium-niobate sample differently treated on two parts by means of the alignment or “poling” technique, with which two opposite ferromagnetic domains are created. The results show that in the sample are present two ferromagnetic domains oriented along opposite directions and having different behaviour under the action of the electrical field.

The apparatus according to the invention can have configurations which are different from the one described above and can be realised with optical components without compromising or changing the apparatus itself.

To conclude, by means of the method and apparatus according to the invention, one has the possibility to determine with a single measurement operation the optical, two-dimensional behaviour of a sample of which one wishes to know the response to an applied electrical field. In particular, it can be extracted a two-dimensional mapping of the electro-optical behaviour of the sample using a single measure.

Moreover, the sample does not undergo any type of invasive treatment and is thus unaltered after the effectuated investigation.

The invention sets itself in the technical field of optics and in the applicative one of the materials' characterisation and manufacture of optical and photonic equipments. Its principal uses are in the measurement of electro-optical properties and in the characterisation of materials utilised in optics and photonics as electro-optical modulators.

The method and apparatus according to the invention enables the estimation of the uniformity of the electro-optical characteristics of a sample under the effect of an applied electrical field. They enable also to analyse complex structures in which are present zones of different nature as ferroelectric domains with different orientation in birefrangent crystals.

Further, the apparatus according to the invention presents particular characteristics of easiness of use, versatility and compactness.

The preferred embodiments have been above described and some modifications of this invention have been suggested, but it should be understood that those skilled in the art can make variations and changes, without so departing from the related scope of protection, as defined by the following claims.

1-46. (canceled)

47. Method for measuring and two-dimensional mapping of the electro-optical properties of materials transparent to the electromagnetic radiation, the method using a Reflective Grating Interferometer (5) wherein a substantially coherent and monochromatic electromagnetic beam is projected onto the transparent material to be analysed, which is subjected to an homogeneous electrical field, in such a way that the beam is enlarged as far as to have a two-dimensional cross section comparable with the dimensions of the material (10) to be analysed, and dividing said electromagnetic beam in two parts, in such a way that one part crosses the material (O), the other part travels undisturbed (R), the two beams (O,R) being recomposed on a recombination element (5a) of the Reflective Grating Interferometer (5), the beam exiting from said Reflective Grating Interferometer (5) being detected by means of a device (7) suited to two-dimensionally detection of such beam, the method further comprising the following subsequent steps:
E. obtaining, by means of an algorithm of digital holography, from the detected electromagnetic beam, which is representative of a two-dimensional image, the phase variation Δø(x,y) of the electromagnetic beam (O) which has crossed the material (10) with respect to that of the undisturbed electromagnetic beam (R);
F. for a number of P times, varying the applied electrical field value and repeating the preceding detection steps;
G. calculating the two-dimensional electro-optical properties of the material (10) under examination using the formula:
$$Δ Φ ( x , y ) = ( \frac{π}{λ} ) \cdot [ - {n}_{0}^{3} ( x , y ) \cdot {r}_{13}^{′} ( x , y ) \cdot V ]$$
where Δφ is the phase difference, V is the value of the voltage difference applied to the material (10) to be analysed, r′₁₃ is the electro-optical parameter, and n₀ is the ordinary refraction index.

48. Method according to claim 47, characterised in that said transparent material (10) to be analysed is a non-centre-symmetrical crystal.

49. Method according to claim 47, characterised in that the dimension perpendicular to the surface of the material (10), of which one detects the two-dimensional electro-optical properties, have thickness of less than 5 mm.

50. Method according to claim 49, characterised in that the dimension perpendicular to the surface of the material (10), of which one detects the two-dimensional electro-optical properties, have thickness of less than 0.5 mm.

51. Method according to claim 47, characterised in that the algorithm of digital holography utilises the numerical calculation of the diffraction integral in the Fresnel approximation, according to the following steps:
transforming the detected interferometric image into a digitised interferogram, composed by a number of Vᵣ values of signal intensity, described by an array H(n·Δx,m·Δy) of N·M values, where n and m are integers, Δx and Δy are the sampling intervals along the x and y axis respectively and (N·Δx)(M·Δy) is the area of the acquired hologram;
multiplying the digitised hologram H(n·Δx,m·Δy) by a digitised replica of the reference beam R(n·Δx,m·Δy), whereby obtaining the relation:
H(nΔx,mΔy)·R(nΔx,mΔy)=R|R|²+R|O|²+RR*O+RRO*
reconstructing the image from the plane in which it has been detected to the plane in which the material to be analysed is put, by means of numerical calculation of the diffraction integral in the Fresnel approximation with the discrete formulation of the Fresnel integral expressed in terms of the Fourier transform, that is:
$$\begin{matrix}Ψ ( l Δ x , k Δ y ) = A {ⅇ}^{\frac{ⅈ π}{λ d} ( {l}^{2} Δ {ξ}^{2} + {k}^{2} Δ {η}^{2} )} DFT \\ {[ R ( n Δ , m Δ y ) H ( n Δ , m Δy ) {ⅇ}^{\frac{ⅈ π}{λ d} ( {n}^{2} Δ {x}^{2} + {m}^{2} Δ {y}^{2} )} ]}_{l , k}\end{matrix}$$
where λ is the wavelength of the source, A is a complex constant, n, m, l, k are integers (−N/2+1<n,l<N/2 e −M/2+1<m,k<M/2), DFT is the discrete Fourier transform, Δx and Δy are the sampling intervals of the interferogram, d is the distance between the plane of the detection device and the observation plane, and, finally, Δξ and Δη represent the spatial sampling intervals in the observation plane and are defined by Δξ=λd/NΔx and Δη=λd/MΔy,
calculating the phase difference according to the formula:
$$Δ ϕ ( l Δ x , k Δ y ) = arctan \frac{Im Ψ ( l Δ x , k Δ y )}{Re Ψ ( l Δ x , k Δ y )}$$

52. Method according to the claim 51, characterised in that the electro-optical parameter r′₁₃ is calculated for each pixel, by the formula:
$$Δ Φ ( x , y ) = ( \frac{π}{λ} ) \cdot [ - {n}_{0}^{3} ( x , y ) \cdot {r}_{13}^{′} ( x , y ) \cdot V ]$$

53. Method according to claim 51, characterised in that it comprises comprises a processing step of the digitised hologram array, and a step of reconstruction in the complex plane starting from the digitised hologram processed in the first step, in the reconstruction step being effectuated a discrete Fresnel transformation starting from an array of Vₑ values, comprising said Vᵣ values of signal intensity values corresponding to as many elementary pixels of the holographic image, the pixel sizes being equal to the holographic image sampling intervals, as well as an integer number p=Vₑ−Vᵣ>0 of constant values equal to OS, corresponding to as many pixels of sizes equal to the ones of the others.

54. Method according to claim 53, characterised in that said p constant values are null values (OS=0).

55. Method according to claim 53, characterised in that said p values are arranged externally to said array of Vᵣ values.

56. Method according to claim 55, characterised in that said p values are arranged in a symmetrical way.

57. Method according to claim 56, characterised in that said p values are arranged in a non-symmetrical way.

58. Method according to claim 53, characterised in that said number Vₑ of values is inversely proportional to the desired pixel size to be obtained for the reconstructed image.

59. Method according to claim 53, characterised in that the digitised hologram is a square array of Vᵣ=Nᵣ·Mᵣ values, each value corresponding to a square pixel of sizes Δx, Δy.

60. Method according to claim 59, characterised in that the hologram reconstructed in the second step is represented by a square array of Vₑ=Nₑ·Mₑ values, each value corresponding to a square pixel of sizes Δξ=(Δd/NₑΔx) and Δη=(λd/MₑΔy), λ being the wavelength of the wave beam striking the object of which the hologram is recorded, and d the distance between the detection device and the object of which the hologram is detected, Δξ and Δη being the reconstructed holographic image sampling intervals.

61. Method according to claim 60, characterised in that Nₑ=(Δd/Δx²), Mₑ=(λd/Δy²), Δξ=Δx, Δη=Δy.

62. Method according to claim 53, characterised in that, after the second step, if each holographic image sampling interval is not equal or less than a certain threshold, the number of values p added to the digitised hologram array is increased and the second step is carried out again.

63. Method according to claim 62, characterised in that said threshold is a function of the signal-to-noise ratio of the holographic image.

64. Apparatus for measuring and two-dimensional mapping of the electro-optical properties of transparent materials, comprising a source (1) of coherent and single-mode electromagnetic beam, a system of transmission and projection (2,3,4) of said beam, a Reflective Grating Interferometer (5) for the treatment of the projected electromagnetic beam, a device (7) for detecting of the electromagnetic beam exiting from the interferometric system and a processing unit (9) for processing the information relevant to the detected electromagnetic beam, characterised in that it further comprises a cell (6) wherein the material (10) to be analysed has to be placed, the cell (6) and said material (10) being crossable by at least a part of the projected electromagnetic beam, the cell (6) being suited to create an electrical field in the material (10).

65. Apparatus for measuring and two-dimensional mapping of the electro-optical properties of transparent materials, comprising a source (1) of coherent and single-mode electromagnetic beam, a system of transmission and projection (2,3,4) of said beam, a Reflective Grating Interferometer (5) for the treatment of the projected electromagnetic beam, a device (7) for detecting of the electromagnetic beam exiting from the interferometric system and a processing unit (9) for processing the information relevant to the detected electromagnetic beam, characterised in that it further comprises a cell (6) wherein the material (10) to be analysed has to be placed, the cell (6) and said material (10) being crossable by at least a part of the projected electromagnetic beam, the cell (6) being suited to create an electrical field in the material (10), characterised in that it implements the method according to claim 47.

66. Apparatus according to claim 64, characterised in that the electromagnetic beam is let from the source (1) in a single-mode, polarisation-maintaining fibre (3) through the fibre coupling system (2).

67. Apparatus according to claim 64, characterised in that the electromagnetic beam is directed towards the Reflective Grating Interferometer (5) in such a way that at least a part of it crosses the cell (6).

68. Apparatus according to claim 67, characterised in that the electromagnetic beam is emitted form an end of the single-mode, polarisation-maintaining fibre (3) towards a parabolic mirror (4), which directs said electromagnetic beam towards the Reflective Grating Interferometer (5), in such a way that a part (O) of the beam crosses the material (10) in the cell (6) and another part (R) arrives undisturbed at the interferometric system (5).

69. Apparatus according to claim 68, characterised in that the parabolic mirror (4) is placed at a distance from the end (3′) of the single-mode, polarisation-maintaining fibre (3) such that the electromagnetic beam is collimated and expanded to dimensions which are comparable to those of the material (10).

70. Apparatus according to claim 64, characterised in that the Reflective Grating Interferometer (5) comprises a wave front division interferometer.

71. Apparatus according to claim 67, characterised in that the Reflective Grating Interferometer (5) comprises a diffraction grating (5a) on which impacts the part (O) of the electromagnetic beam which has crossed the material (10).

72. Apparatus according to claim 67, characterised in that the Reflective Grating Interferometer (5) comprise a flat mirror (5b) mounted on adjustable supports on which impacts the part (R) of the electromagnetic beam which has not crossed the material (10).

73. Apparatus according to claim 72, when depending on claim 26, characterised in that the mirror (5b) is controlled so that the electromagnetic beam is redirected towards the diffraction grating (5a).

74. Apparatus according to claim 72, characterised in that the processing electronic unit (9) generates a signal suited to control said adjustable supports.

75. Apparatus according to claim 64, characterised in that the processing electronic unit (9) generates signals suited to control the emission of the coherent light by said source (1) and/or the electrical field applied to the material (10).

76. Apparatus according to claim 64, characterised in that the detection device (7) of the electromagnetic beam is a two-dimensional array of detectors of electromagnetic radiation.

77. Apparatus according to claim 76, characterised in that the detection device (7) is a CCD camera.

78. Apparatus for measuring and two-dimensional mapping of the electro-optical properties of transparent materials, comprising a source (1) of coherent and single-mode electromagnetic beam, a system of transmission and projection (2,3,4) of said beam, a Reflective Grating Interferometer (5) for the treatment of the projected electromagnetic beam, a device (7) for detecting of the electromagnetic beam exiting from the interferometric system and a processing unit (9) for processing the information relevant to the detected electromagnetic beam, characterised in that it further comprises a cell (6) wherein the material (10) to be analysed has to be placed, the cell (6) and said material (10) being crossable by at least a part of the projected electromagnetic beam, the cell (6) being suited to create an electrical field in the material (10), characterised in that the processing unit (9) processes the data according to step E and/or G of the method according to claim 47.
